(19) United States
(12) Patent Application Publication
(10) Pub. No.: US 2007/0168575 A1
(43) Pub. Date: Jul. 19, 2007

(54) Non-volatile storage device with thin display unit

(76) Inventors: Li-Pai Chen, Chung Ho City (TW); Ming-Dar Chen, Chung Ho City (TW); Hsiang-An Hsieh, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/358,091

(22) Filed: Feb. 22, 2006

Related U.S. Application Data
(63) Continuation-in-part of application No. 11/260,399, filed on Oct. 28, 2005.

(51) Int. Cl. G06F 3/00

(52) U.S. Cl. 710/15

(57) ABSTRACT

A non-volatile storage device with a thin display unit is described. The non-volatile storage device has a thin display unit, a first interface, a non-volatile storage unit, a second interface, an electric material and a package unit. Therein, the non-volatile storage unit further has a controller and a non-volatile storage medium. The package unit further has a display window. The non-volatile storage unit sends status information of the non-volatile storage medium to the thin display unit via the electric material between the first interface and the second interface. Then, a user can view the status information shown on the display unit via the display window directly.

### CROSS-REFERENCE TO RELATED APPLICATIONS

This Application is a Continuation-in-part of application Ser. No. 11/260399, filed on 28 Oct. 2005, and entitled NON-VOLATILE STORAGE DEVICE WITH THIN DISPLAY UNIT.

### BACKGROUND OF THE INVENTION

1. Field of the Invention

The present invention is related to a non-volatile storage device with a display unit, and more particularly to a non-volatile storage device that has a thin display unit.

2. Description of Related Art

Conventional non-volatile storage devices, such as compact flash (CF) memory cards, multimedia cards (MMC), secure digital (SD) memory cards, memory stick (MS) cards, and thumb drives with USB interfaces, generally don't have display units. Apart from the labels attached to the storage devices that show the storage capacities, the storage devices cannot show their current status when in use.

Although some portable devices, for example, MP3 players and backup memory cards, have display units that can show their remaining memory capacity, they need to have built-in power supplies. Moreover, the display units used by these portable devices are too large in size. Due to these two problems, the memory cards with compact sizes cannot be equipped with display units. For conventional USB thumb drives, although some of them have been equipped with display units, their sizes cannot be further reduced because of the large-scale display unit.

Taiwan Utility Patent No. M253035 discloses a storage device with a display unit that displays its memory capacity. Although the technique described in this patent shows information regarding the device's storage capacity, it cannot be applied to devices that are compact in size.

Accordingly, as discussed above, the prior art still has some drawbacks that can be improved upon. The present invention aims to resolve the drawbacks of the prior art.

### SUMMARY OF THE INVENTION

An objective of the present invention is to provide a non-volatile storage device with a thin display unit. The present invention uses a display unit that has a smaller size connect with non-volatile storage unit by an electric material for reducing the overall size and increasing the electric conductivity. Hence, the present invention can be applied to devices with compact sizes to equip them with display units to show their current status.

For achieving the object above, the present invention provides a non-volatile storage device with a thin display unit that comprise a thin display unit, a first interface, a non-volatile storage unit, a second interface, an electric material and a package unit. Therein, the non-volatile storage unit further has a controller and a non-volatile storage medium. The package unit further has a display window. The non-volatile storage unit sends status information of the non-volatile storage medium to the thin display unit via the electric material between the first interface and the second interface. Then, a user can view the status information shown on the display unit via the display window directly.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of the present invention;

FIG. 2 is a cross-sectional view of the first embodiment in accordance with the present invention;

FIG. 3 is a break down drawing of the second embodiment in accordance with the present invention; and

FIG. 4 shows an application of the present invention for the SD memory card.

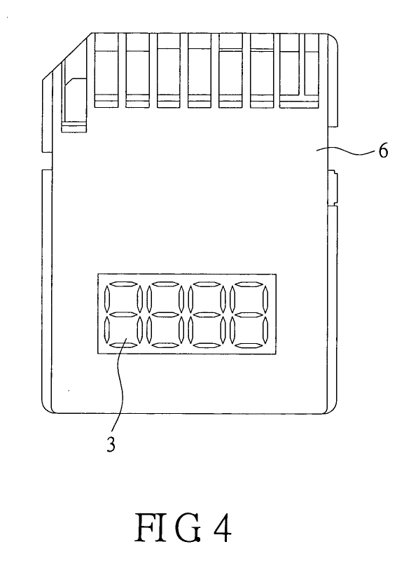

### DETAILED DESCRIPTION OF PREFERRED EMBODIMENTS

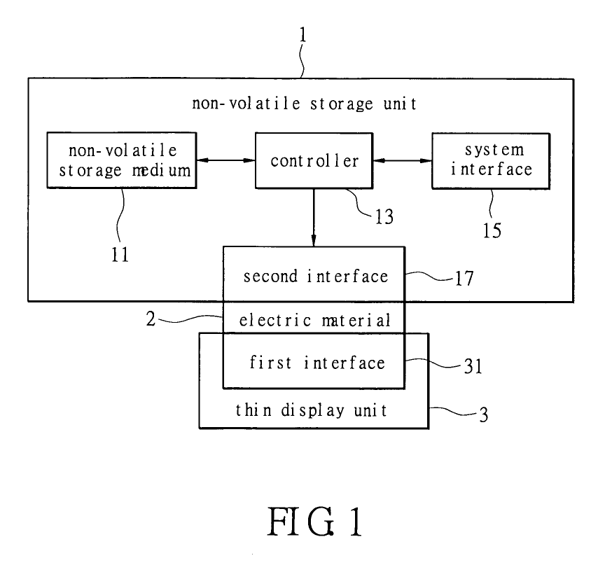

Reference is made to FIG. 1, which is a block diagram of the present invention. In the figure, the non-volatile storage unit 1 uses a controller 13 to connect an external application system via a system interface 15 for transmitting and storing digital information. The controller 13 is also used to read and analyze information recorded in the non-volatile storage medium 11 and sends status information of the non-volatile storage medium 11 to a first interface 31 via a second interface 17 to show the status information of the non-volatile storage medium 11 on the thin display unit 3. Therein use an electric material 2 as a medium between the first interface 31 and the second interface 17 for increasing electric conductivity between the first interface 31 and the second interface 17. Further, the electric material 2 is an anisotropic conductive film (ACF).

The anisotropic conductive film comprises binder and conducting particles. The conducting particle can be carbon black, metal powder, high molecular plastic ball coated metal on the surface or metal particle coated isolation resin etc. Presently, the metal powder and the high molecular plastic ball coated metal on the surface is mainly using, that features the plastic having compressibility, so as to increasing contacting area between electrode and conducting particles. Therefore, after install the electric material between the first interface 31 and the second interface 17, use suitable pressure, temperature and time to reduce viscosity of resin to start flowing, and than presses quickly to make the conducting particles contact with conductive contact of the first interface 31 and conductive contact of the second interface 17, and that conducting direction just according the pressure direction to conduct.

The thin display unit 3 of the present invention is characterized by its use of a substrate with a small thickness. The substrate has an optoelectronic material whose stable status is changed due to the affection of electric fields, electric currents or other electromagnetic effects. After the optoelectronic material is arranged appropriately on the substrate, the status information can be shown thereon by changing its stable status.

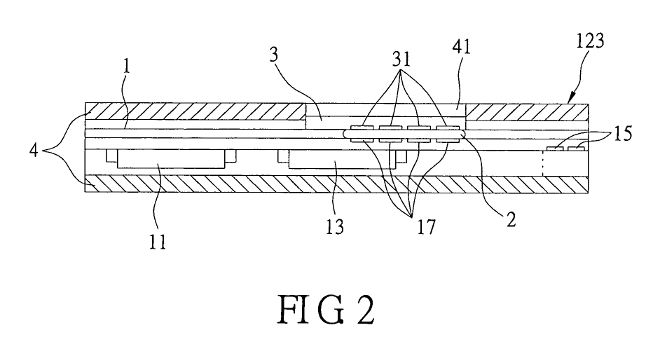

The structure of the first embodiment of present invention is shown in FIG. 2, which is a cross-sectional view of the first embodiment in accordance with the present invention. Therein, the thin display unit 3 is a bistable one. Except for having a small size, the thin display unit 3 can constantly show the status of the Non-volatile storage device 123 without connecting to the application system or having a built-in power supply.

The thin display unit 3 is inserted in the package unit 4. The package unit 4 forms a periphery of the Non-volatile storage device 123 and has a display window 41 formed corresponding to the location of the thin display unit 3. Furthermore, the package unit 4 can be made of a transparent material for displaying the information shown on the thin display unit 3. Wherein the thin display unit having a first interface 31, the first interface 31 include at least one conductive contact made of metal.

Furthermore, the non-volatile storage unit 1 includes at least one non-volatile storage medium 11, a controller 13, a system interface 15 and a second interface 17. Therein, the second interface 17 include at least one conductive contact made of metal that be installed by aiming at the conductive contact of the first interface 31. Between the first interface 31 and the second interface 17 install an electric material 2, and the electric material 2 is an anisotropic conductive film (ACF). The first interface 31 and the second interface 17 presses the anisotropic conductive film by characteristic of the anisotropic conductive film and packaging of the package unit 4 for forming electric conduction of perpendicular direction between the first interface 31 and the second interface 17 so that achieving electrically connection between the thin display unit 3 and the non-volatile storage unit 1. Thereby, the controller 13 transmit the status information of the non-volatile storage medium 11 to the thin display unit 3 for displaying. In other words, the controller 13 connects to the first interface 31 via the second interface 17 to control the thin display unit 3 showing the status information. Furthermore, the controller 13 also connects to an external application system via the system interface 15 to store and transmit digital information.

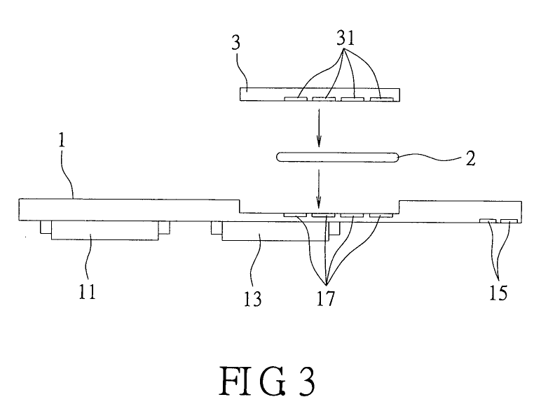

Reference is made to FIG. 3, which is a break down drawing of the second embodiment in accordance with the present invention. The installation of the above-mentioned thin display unit 3 into the package unit 4 can be performed as shown in FIG. 3. The thin display unit 3 is inserted in the non-volatile storage unit 1, and between the thin display unit 3 and the non-volatile storage unit 1 have the electric material 2, wherein the electric material 2 is an anisotropic conductive film (ACF). And then by the pressing of package to makes the first interface 31 electrically connect with the second interface 17 and to makes the thin display unit 3 electrically connecting to the non-volatile storage unit 1. Next, the package unit 4 is applied for packaging.

The package unit 4 includes an upper cover and a lower cover or is composed of multiple components. The package unit 4 can also have a single shell with a package material used to glue the components when they are placed in the shell. The package unit 4 can also be formed integrally via a mold after all of the components are combined.

To sum up, the present invention can be applied for various non-volatile storage devices that are small in size, such as compact flash (CF) memory cards, multimedia cards (MMC), secure digital (SD) memory cards, and memory stick (MS) cards. FIG. 6 shows an application of the present invention for the SD memory card. As shown in FIG. 6, status information can be shown on the SD memory card 6. Thus, the problem of the prior art that display units cannot be disposed on some storage devices because of their small sizes is overcome. Furthermore, by using the present invention, the size of conventional USB thumb drives with display units can be further reduced.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A non-volatile storage device, comprising:
a thin display unit used to display status information of the non-volatile storage device;
a first interface installed in the thin display unit;
a non-volatile storage unit used to store and to transmit digital information;
a second interface installed in the non-volatile storage unit;
a electric material installed between the first interface and the second interface and used for transmitting signal between the non-volatile storage unit and the thin display unit; and
a package unit forming a periphery of the non-volatile storage device and having a display window for displaying the status information.

2. The non-volatile storage device as claimed in claim 1, wherein the thin display unit is a bistable one.

3. The non-volatile storage device as claimed in claim 1, wherein the non-volatile storage unit connects external application system through a system interface for storing and transmitting the digital information.

4. The non-volatile storage device as claimed in claim 1, wherein the non-volatile storage unit further includes a controller and at least one non-volatile storage medium, wherein the controller read and analyze specific information recorded in the non-volatile storage medium for displaying the status information of the non-volatile storage medium on the thin display unit.

5. The non-volatile storage device as claimed in claim 4, wherein the non-volatile storage unit connects external application system through a system interface by the controller for storing and transmitting the digital information.

6. The non-volatile storage device as claimed in claim 4, wherein the controller transmits signal to the thin display unit by the second interface for controlling the status information displayed on the thin display unit.

7. The non-volatile storage device as claimed in claim 1, wherein the thin display unit is installed in the package unit.

8. The non-volatile storage device as claimed in claim 1, wherein the thin display unit is installed on the non-volatile storage unit.

9. The non-volatile storage device as claimed in claim 1, wherein the package unit has an upper cover and a lower cover.

10. The non-volatile storage device as claimed in claim 1, wherein the package unit is a single shell with a package material used to glue the components of the non-volatile storage device onto the shell.

11. The non-volatile storage device as claimed in claim 1, wherein the package unit is formed integrally via a mold after the components of the non-volatile storage are combined.

12. The non-volatile storage device as claimed in claim 1, wherein the package unit is composed of multiple components.

13. The non-volatile storage device as claimed in claim 1, wherein the package unit is made of a transparent material.

14. The non-volatile storage device as claimed in claim 1, wherein the first interface and the second interface are respective has at least one conductive contact.

15. The non-volatile storage device as claimed in claim 14, wherein conductive contact of the first interface is aim at conductive contact of the second interface.

16. The non-volatile storage device as claimed in claim 1, wherein the electric material is an anisotropic conductive film (ACF).
